(19) United States
(12) Patent Application Publication
(10) Pub. No.: US 2019/0147685 A1
(43) Pub. Date: May 16, 2019

(54) VENDING MACHINE HAVING MODULAR PRODUCT DISPENSING CHANNELS

(71) Applicant: BRIGHTON-BEST INTERNATIONAL (TAIWAN) INC., Tainan City (TW)

(72) Inventors: Ti Chin CHANG, Tainan City (TW); Tong Tsan CHIEN, Tainan City (TW)

(21) Appl. No.: 16/191,414

(22) Filed: Nov. 14, 2018

Related U.S. Application Data
(60) Provisional application No. 62/620,403, filed on Jan. 22, 2018.
(60) Provisional application No. 62/753,912, filed on Oct. 31, 2018.

(30) Foreign Application Priority Data
Nov. 14, 2017 (CN) 201711123184.0
Nov. 14, 2017 (CN) 201721514025.9
Nov. 14, 2017 (TW) 106139365
Nov. 14, 2017 (TW) 106216940

(51) Int. Cl. G07F 11/00; G05B 11/01

(52) U.S. Cl. CPC G07F 11/007; G05B 11/01

(57) ABSTRACT

A vending machine having modular dispensing modules configured to define product dispensing channels. The dispensing modules are each pre-configured with an integral drive mechanism (an actuator, such as a motor drive, activating a product conveyor) for advancing product items to a dispensing location within a vending machine. Each dispensing module is self-contained, and pre-configured by the vending machine supplier. The vending machine owner/operator does not need to configure/reconfigure or otherwise modify any component in the dispensing modules. The dispensing modules form the building blocks for configuring the product dispensing channels in a vending machine to accommodate dispensing products of various sizes and/or forms. The dispensing modules thus define the product dispensing channels in the vending machine.

This application claims the priority of (a) U.S. Provisional Patent Application No. 62/620,403 filed on Jan. 22, 2018; (b) U.S. Provisional Patent Application No. 62/753,912 filed on Oct. 31, 2018; (c) Taiwan Patent Application No. 106139365 filed on Nov. 14, 2017; (d) Taiwan Patent Application No. 106216940 filed on Nov. 14, 2017; (e) China Patent Application No. 201711123184.0 filed on Nov. 14, 2017; and (f) China Patent Application No. 201721514025.9 filed on Nov. 14, 2017. These applications are fully incorporated by reference as if fully set forth herein. All publications noted below are fully incorporated by reference as if fully set forth herein.

### BACKGROUND OF THE INVENTION

### 1. Field of the Invention

The invention relates to vending machine and more particularly to a vending machine having modular product vending/dispensing channels for vending/dispensing products.

### 2. Description of Related Art

Conventional vending machine manufacturers solely manufacture and sell vending machines. Depending on the size of the products to be supported for dispensing by the vending machine, the vending machine may need to be modified to reconfigure the product dispensing channels. Reconfiguration of the product dispensing channels is done by an owner and/or operator of the vending machine. For a helical spring/corkscrew type product dispensing channel, it may be desirable to reconfigure a single corkscrew configuration to a double corkscrew configuration, so as to accommodate a larger size product packaging. The reconfiguration can be done by removing a divider between two adjacent product dispensing channels, removing one motor for one of the corkscrews, and placing the other motor between the product dispensing channels. Another approach is to remove a divider between two adjacent product dispensing channels and reconfigure a mechanism to turn the corkscrews in complementary clockwise and counterclockwise manner to move a product package forward. With either approach, it is required to manually label the product dispensing channels and the motors as well as modify the control program of the vending machine. Further, storage of the detached components in a suitable place is a time consuming and tedious task. Otherwise, components may be lost and not available for further reconfiguration back to the original configuration.

Another approach is that the owner/operator can send employees to the vending machine manufacturer to learn how to repair and replace components as well as set and reconfigure the vending machine system. However, this approach adds further operating overhead for the vending machine. Furthermore, reconfiguration involves challenging steps which cannot be mastered after a short training. Failure to properly reconfigure a vending machine by a non-proficient person would lead to further operating overhead in maintenance/repair, and down time of the vending machine leading to lost sales. As a result, the training program fails.

Accordingly, there remains a need for improvement for a vending machine that can be easily reconfigured to accommodate products or various sizes and shapes.

### SUMMARY OF THE INVENTION

The present invention overcomes the drawbacks to the prior art vending machines. The present invention is directed to a vending machine that allows for easy configuration/reconfiguration of product dispensing channels by using modular dispensing channels (hereinafter “dispensing modules”) to configure and define the product dispensing channels in the vending machine. The dispensing modules are each pre-configured with an integral drive mechanism (e.g., an actuator, such as a motor drive, activating a product conveyor, such as a corkscrew conveyor or a belt conveyor, etc.) for advancing product items to a dispensing location within a vending machine. Each dispensing module is self-contained, and pre-configured by the vending machine supplier. The vending machine owner/operator does not need to configure/reconfigure or otherwise modify any component in the dispensing modules. The dispensing modules form the building blocks for configuring the product dispensing channels in a vending machine to accommodate dispensing products of various sizes and/or forms. The dispensing modules thus define the product dispensing channels in the vending machine.

The dispensing modules are plug-and-play in the vending machine. Configuration/reconfiguration of the vending machine with the desired product dispensing channels can simply be achieved by plugging in a desired set of pre-configured dispensing modules, which does not require formal or structured training of the vending machine operator. Given the modular nature of the dispensing modules, there is increased flexibility to configure dispensing channels for various products at desired placements in the vending machine to attract attention of users for the products in the vending machine. A dispensing module may be relocated in the vending machine without having to remove the products supported in that dispensing module, which further simplifies reconfiguration of the product channels in the vending machine.

In one aspect of the present invention, the dispensing modules are interchangeable with dispensing modules of similar form factor (e.g., a single corkscrew dispensing module can be replaced with a conveyor dispensing module of similar width). Two or more dispensing modules of smaller form factor may be replaced by another dispensing module of larger form factor, or vice versa.

Each product dispensing module has a body having a width form factor that is a multiple of the smallest width form factor (i.e., the smallest characteristic width W) of the body of the narrowest product dispensing module. For example, for a single corkscrew dispensing module has a body of width W, another dispensing module for replacement would have a body of similar width (i.e., 1×W), or a larger width substantially 1.5×W, 2×W, 2.5×W, 3×, or . . . to accommodate wider products to be dispensed. For example, a double corkscrew dispensing module may have a body width of substantially 2 W, 2.5 W, or etc. . . . In one embodiment, the multiple is an integral multiple N, where N=1, 2, 3, . . . .

The dispensing modules may be pre-configured with different product dispensing mechanisms, including a drive mechanism (e.g., an electric motor) actuating a product conveying mechanism. Without limitations, examples of dispensing modules having product conveying mechanisms include modules having a single corkscrew, modules having double corkscrews, modules respectively having corkscrews of different pitches, modules having belt conveyors and further belt conveyors respectively of different widths, modules having hanging supports/hangers for supporting and advancing products along a track. An electric motor and appropriate gears and/or levers are provided to actuate the conveying mechanism

Each dispensing module is provided with a digital display at the front of the module body to identify the module to distinguish from other modules. At the rear of the module body, an electrical connector is provided, which when plugged with an exterior connector to supply power and/or control signals to the electrical devices (e.g., the motor drive and the digital display) on the dispensing module. In one embodiment, to provide compatibility between dispensing modules, the connector is place in the same location with respect to a same side of every dispensing module of same or different form factor. At the bottom surface of each dispensing module, one or more protruding members (e.g., anchors, stubs or hooks) are provided to engage complementary slot(s) on a supporting shelf/tray discussed below to positively index to engage the dispensing modules on the supporting shelf/tray.

In a further embodiment, each dispensing module is provided with a vertical wall at at least one side of the body of the dispensing module, so as to provide a partition with the adjacent dispensing module.

In the product dispensing chamber (i.e., where products are supported by the dispensing modules) of the vending machine, frames or internal sidewalls support shelves that supporting the dispensing modules at various vertical levels. In one embodiment, the shelves are in the form of trays supported by tracks on the sidewalls of the product dispensing chamber. The trays can be pulled out of and inserted into the product dispensing chamber to facilitate removal and placement of dispensing modules. At a rear wall of each tray, a linear array of electrical connectors at fixed spacing is provided, which are complementary to the electrical connectors on dispensing modules (e.g., female connectors at the rear wall of the tray, and male connectors at the rear of the body of dispensing modules). The pitch/centerline spacing of the connectors on the trays is fixed to accommodate the centerline spacing of the connectors on a horizontal row of dispensing modules of the smallest width form factor. For example, if the smallest dispensing modules each has a width W, and a row of the smallest dispensing modules are to be configured side-by-side with substantially little or no spacing therebetween on the tray, the centerline spacing between the connectors on the trays should be substantially W.

Indexing slots are provided across the bottom panel of the tray, which are located in relation to the connectors at the rear of the tray, to index accurate placement of the dispensing modules on the tray with respect to the connectors on the tray and the dispensing modules, with the protruding members at the bottom of the dispensing modules engaging the slots on the tray. Upon placing a dispensing module on the tray and pushing the dispensing module towards the rear of the tray, the connector at the rear of the dispensing module engages the connector at the rear of the tray, thereby providing electrical connection to provide electrical power, and control data and/or signals to the dispensing module from a controller in the vending machine. The controller recognizes the connectors on the tray that are active, i.e., connected to respective dispensing modules, thereby recognizing the locations of the dispensing modules with respect to the product dispensing chamber.

In one embodiment, the particular dispensing modules may be additionally configured to be automatically recognized by the controller. The connector on a dispensing module may be provided with a unique electronic identifier (e.g., a serial number or other unique identification number) recognized by the controller, so that the controller will be able to distinguish the type and other characteristics and features of the dispensing module of dispensing module (e.g., the product dispensing conveying mechanism such as single corkscrew, double corkscrews, belt conveyor, hangers, etc., the capacity of the dispensing module). This would make it foolproof for an operator to configure the product dispensing channels using the dispensing modules in the product dispensing chamber, as it would reduce the amount of information that is needed to be entered by the operator to correspond to the configured product dispensing channels using the dispensing modules, thus reducing opportunities for human errors.

In another embodiment, instead of trays, shelves having the slots may be provided, and a rectangular array of connectors (e.g., an L×M array female connectors) may be provided at a separate back panel towards the rear of the product chamber.

In one embodiment, one of the objectives of the invention to provide a vending machine comprising a frame including a display on a front surface, a keypad on the front surface, a sensor on the front surface, a window on the front surface, an opening under the window, and a controller for controlling the display, the keypad, and the sensor; a plurality of rows of product dispensing modules, each product dispensing module including a body, a stop member at one end of the body, a drive device projecting outward from the stop member, a connector projecting outward from the stop member, a biasing member having one end anchored on an inner surface of the stop member, and a display member on the other end of the body wherein the biasing member is one of a helical spring/corkscrew, two corkscrews, and a conveyor; and a plurality of trays, each for supporting the rows of the product dispensing modules and including a plurality of cavities for securing to the product dispensing modules, and a plurality of connection members, each configured to connect to the connector.

The above and other objects, features and advantages of the invention will become apparent from the following detailed description considered with the accompanying drawings.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1 is a front view of a vending machine according to one embodiment of the invention;

FIG. 2 is an enlarged fragmentary front view of the vending machine in accordance with one embodiment of the invention;

FIG. 3 is a schematic block diagram of a controlling system of the vending machine in accordance with one embodiment of the invention;

FIG. 4A is a perspective view of a product dispensing module having a single corkscrew in accordance with one embodiment of the invention; FIG. 4B is a bottom perspective view showing the protruding members for engaging the slots on the bottom panel of a tray in accordance with one embodiment of the invention;

FIG. 5 is a perspective view of a product dispensing module having two parallel complementary corkscrews in accordance with one embodiment of the invention;

FIG. 6 is a perspective view of a product dispensing module having a belt conveyor in accordance with one embodiment of the invention;

FIG. 7 is a top view of a tray with product dispensing modules disposed thereon in accordance with one embodiment of the invention;

FIG. 8 schematically depicts connection members disposed at the rear wall of the trays in accordance with one embodiment of the invention;

FIG. 9 is a top view of a tray illustrating removal of two product dispensing modules in accordance with one embodiment of the invention;

FIG. 10 is a top view similar to FIG. 9 illustrating placement of a wider product dispensing module having double corkscrews in accordance with one embodiment of the invention; and

FIG. 11 schematically illustrates a user interacting with the user interface devices on the vending machine in accordance with one embodiment of the invention.

### DETAILED DESCRIPTION OF THE INVENTION

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention.

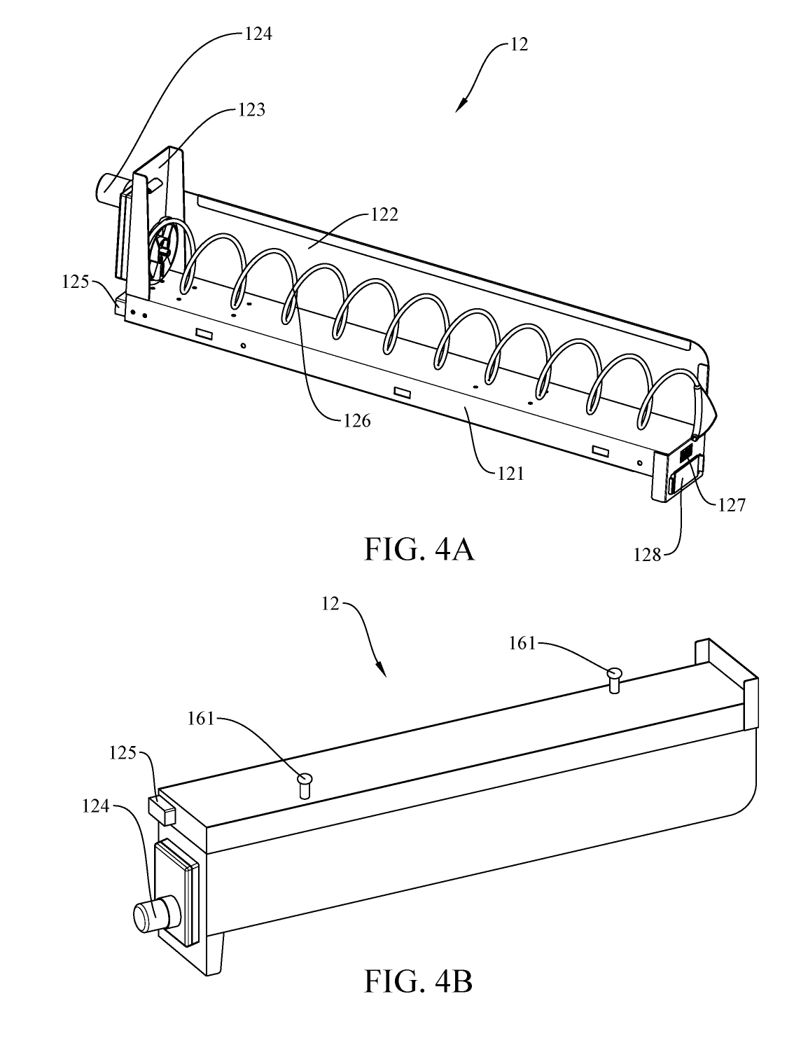

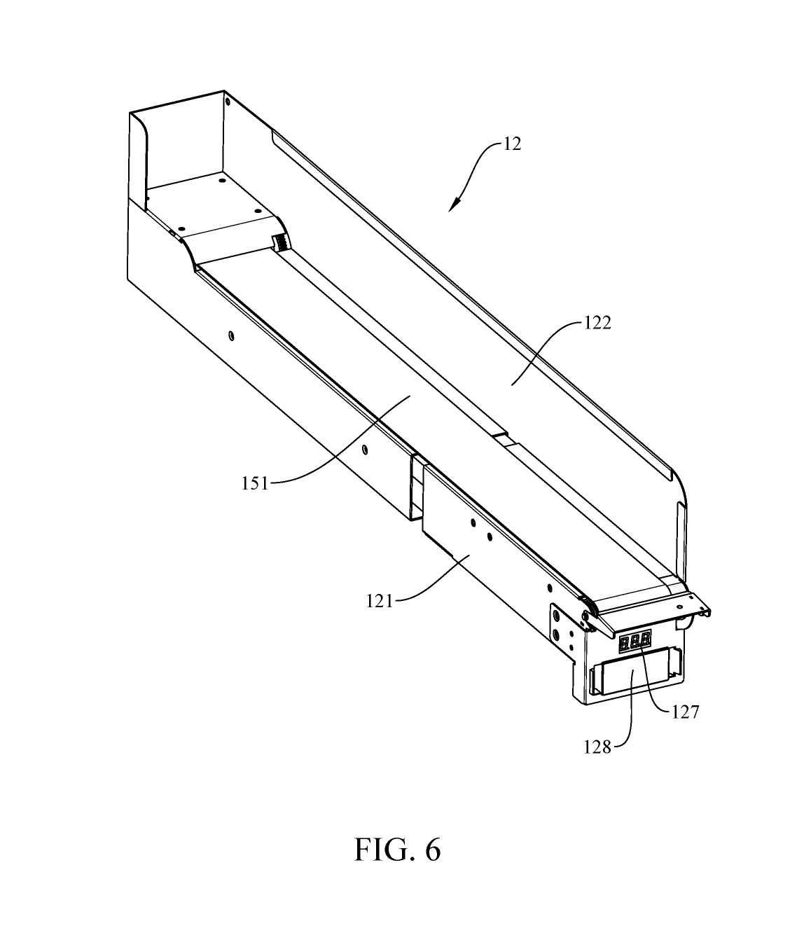

Referring to the embodiments illustrated in the drawings, the present invention overcomes the drawbacks to the prior art vending machines. The present invention is directed to a vending machine 1 that allows for easy configuration and/or reconfiguration of product dispensing channels by using modular dispensing channels (hereinafter “dispensing modules”) to configure and define the product dispensing channels in the vending machine. The dispensing modules 12 are each pre-configured with an integral drive mechanism (e.g., an actuator, such as a motor drive 124, activating a product conveyor, such as a corkscrew conveyor (FIG. 4A) or a belt conveyor (FIG. 6), etc.) for advancing product items to a dispensing location (behind opening 115) within the vending machine 1. Each dispensing module 12 is self-contained, and pre-configured by the vending machine supplier. The vending machine owner/operator does not need to configure/reconfigure or otherwise modify any component in the dispensing modules. The dispensing modules form the building blocks for configuring the product dispensing channels in a vending machine to accommodate dispensing products of various sizes and/or forms. The dispensing modules thus define the product dispensing channels in the vending machine.

The dispensing modules 12 are plug-and-play in the vending machine 1. Configuration/reconfiguration of the vending machine with the desired product dispensing channels can simply be achieved by plugging in a desired set of pre-configured dispensing modules 12, which does not require formal or structured training of the vending machine operator. Given the modular nature of the dispensing modules 12, there is increased flexibility to configure dispensing channels for various products at desired placements in the vending machine to attract attention of users for the products in the vending machine. A dispensing module 12 may be relocated in the vending machine without having to remove the products supported in that dispensing module, which further simplifies reconfiguration of the product channels in the vending machine 1.

In one aspect of the present invention, the dispensing modules 12 are interchangeable with dispensing modules of similar form factor (e.g., a single corkscrew dispensing module (FIG. 4A) can be replaced with a conveyor dispensing module of similar width (FIG. 6)). Two or more dispensing modules of smaller form factor may be replaced by another dispensing module of larger form factor, or vice versa.

Each product dispensing module 12 has a body 121 having a width form factor that is a multiple of the smallest width form factor (i.e., the smallest characteristic width W) of the body 121 of the narrowest product dispensing module 12. For example, for a single corkscrew dispensing module has a body 121 of width W, another dispensing module for replacement would have a body 121 of similar width (i.e., 1×W), or a larger width substantially 1.5×W, 2×W, 2.5×W, 3×, or . . . to accommodate wider products to be dispensed. For example, a double corkscrew dispensing module may have a body width of substantially 2 W, 2.5 W, or etc. . . . In one embodiment, the multiple is an integral multiple N, where N=1, 2, 3, . . . .

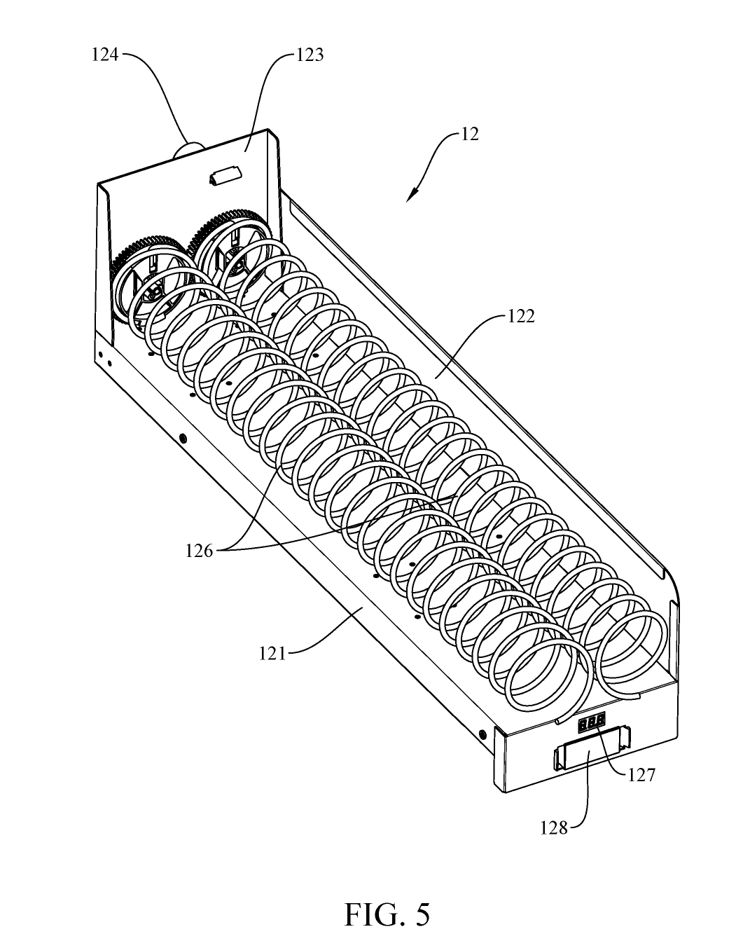

The dispensing modules 12 may be pre-configured with different product dispensing mechanisms, including a drive mechanism 124 (e.g., an electric motor) actuating a product conveying mechanism. Without limitations, examples of dispensing modules having product conveying mechanisms include modules having a single corkscrew (FIG. 4A), modules having double corkscrews (FIG. 5), modules respectively having corkscrews of different pitches, modules having belt conveyors (FIG. 6) and further belt conveyors respectively of different widths, modules having hanging supports/hangers for supporting and advancing products along a track. An electric motor and appropriate gears and/or levers are provided to actuate the conveying mechanism.

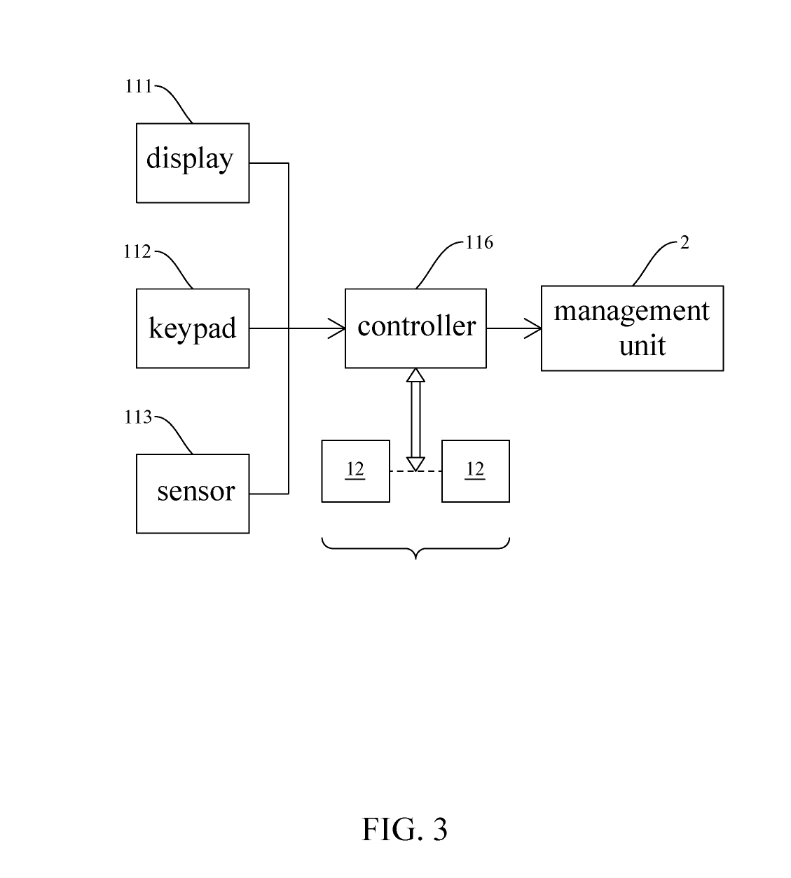

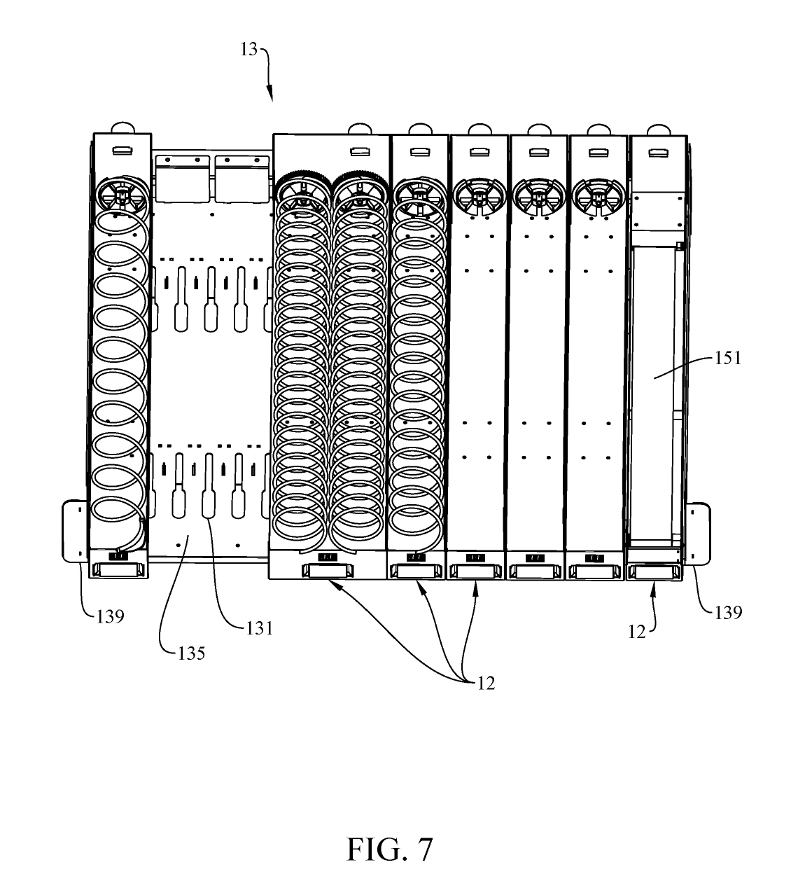

Each dispensing module 12 is provided with a digital display 127 at the front of the module body 121 to identify the dispensing module to distinguish from other dispensing modules. At the rear of the module body 121, an electrical connector 125 is provided, which when plugged with an exterior connector connected to the controller 116 (FIG. 3) to supply power and/or control signals to the electrical devices (e.g., the motor drive and the digital display) on the dispensing module 12. In one embodiment, to provide compatibility between dispensing modules 12, the connector 125 is place in the same location with respect to a same side of each dispensing module 12 of same or different form factor. As seen in FIG. 4B, at the bottom surface of each dispensing module 12, one or more protruding members 161 (e.g., anchors, stubs or hooks) are provided to engage complementary slot(s) 131 (FIG. 7) on a supporting shelf/tray/panel 135 discussed below to positively index to engage the dispensing modules 12 on the supporting shelf/tray 135.

In a further embodiment, each dispensing module 122 is provided with a vertical side wall at at least one side of the body 121 of the dispensing module 12, so as to provide a partition with the adjacent dispensing module to separate the product dispensing channels of the adjacent dispensing modules.

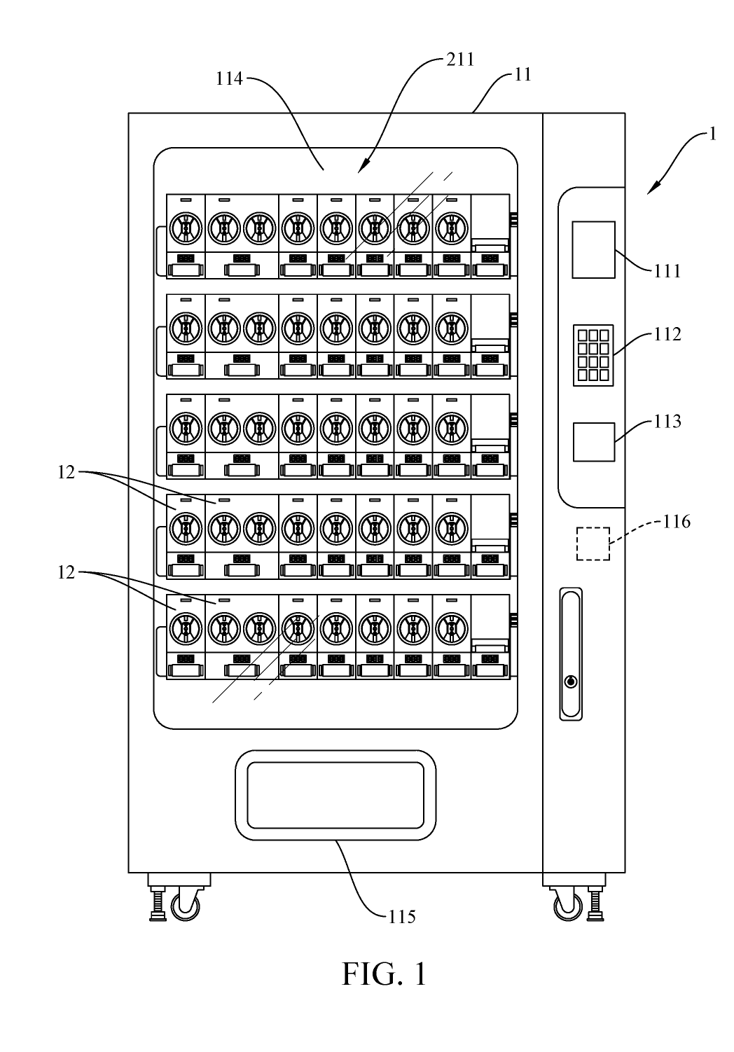

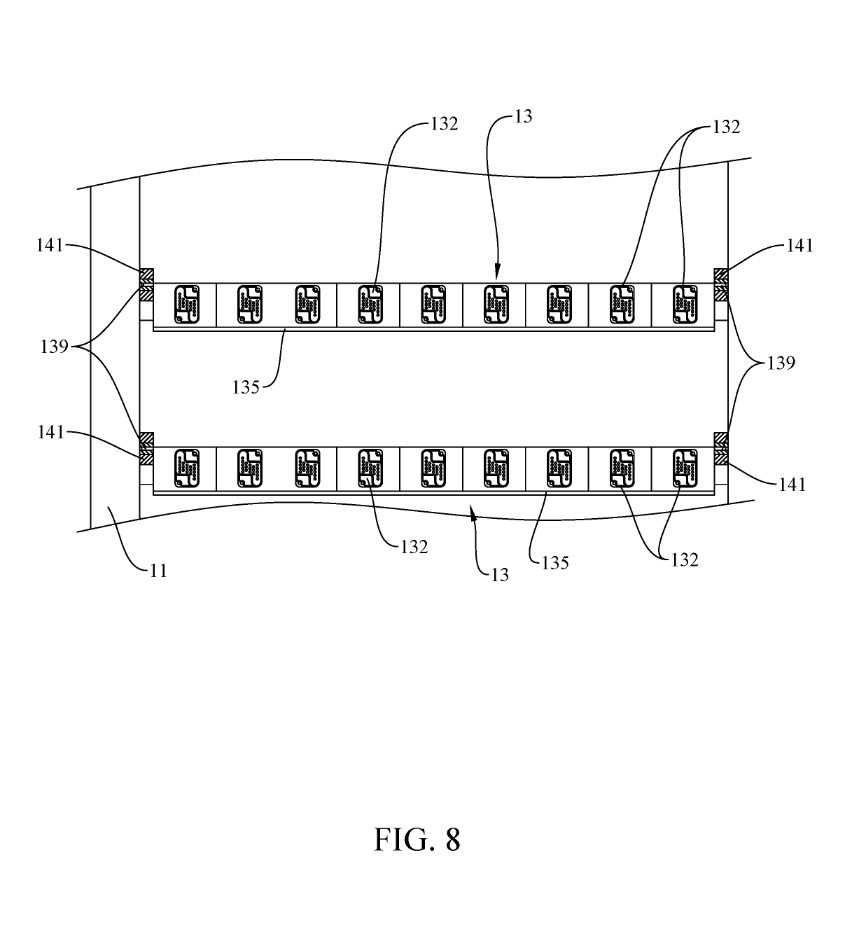

As shown in FIG. 8, in the product dispensing chamber 211 (i.e., where products are supported by the dispensing modules) of the vending machine 1, housing 11 with frames or internal sidewalls support shelves support the dispensing modules 12 at various vertical levels (as seen through the transparent windows 114 in FIG. 1). As shown in FIG. 1, a rectangular array of dispensing modules 12 are supported in the product dispensing chamber 211. In one embodiment, the shelves are in the form of trays 13 supported by tracks of supporting rails 141 on the sidewalls of the product dispensing chamber 211. The trays 13 can be pulled out of and inserted into the product dispensing chamber 211 to facilitate removal and placement of dispensing modules 12. As shown in FIG. 8, at a rear wall of each tray 13, a linear array of electrical connectors 132 at fixed spacing is provided, which are complementary to the electrical connectors 125 at the rear of dispensing modules 12 (e.g., female connectors at the rear wall of the tray, and male connectors at the rear of the body 121 of dispensing modules 12). The pitch/centerline spacing of the connectors 132 on the trays 13 is fixed to accommodate the centerline spacing of the connectors 125 on a horizontal row of dispensing modules 12 of the smallest width form factor. For example, if the smallest dispensing modules 12 each has a width W, and a row of the smallest dispensing modules 12 are to be configured side-by-side with substantially little or no spacing therebetween on the tray 13, the centerline spacing between the connectors on the trays should be substantially W.

As shown in FIG. 7, indexing slots 131 are provided across the bottom panel 135 (of a shelf) of the tray 13, which are located in relation to the connectors 132 at the rear of the tray 13, to index accurate placement of the dispensing modules 12 on the tray 13 with respect to the connectors 132 on the tray and the connectors 125 on the dispensing modules, with the protruding members 161 at the bottom of the dispensing modules engaging the slots 131 on the tray 13. Upon placing a dispensing module 12 on the tray 13 and pushing the dispensing module 12 towards the rear of the tray 13, the connector 125 at the rear of the dispensing module 12 engages the connector 132 at the rear of the tray 13, thereby providing electrical connection to provide electrical power and control data and/or signals to the dispensing module 12 from a controller 116 (FIG. 3) in the vending machine. The controller 116 recognizes the connectors 132 on the tray 13 that are active, i.e., connected to respective dispensing modules 12, thereby identifying the locations of the dispensing modules 12 with respect to the product dispensing chamber 211.

In one embodiment, the particular dispensing modules 12 may be additionally configured to be automatically recognized by the controller 116 without user/operator intervention. The connector 125 on a dispensing module 12 may be provided with a unique electronic identifier (e.g., a serial number or other unique identification number) recognized by the controller 116, so that the controller 116 will be able to distinguish the type and other characteristics and features of the dispensing module of dispensing module (e.g., the product dispensing conveying mechanism such as single corkscrew, double corkscrews, belt conveyor, hangers, etc., the capacity of the dispensing module). This would make it foolproof for an operator to configure the product dispensing channels using the dispensing modules in the product dispensing chamber, as it would reduce the amount of information that is needed to be entered by the operator to correspond to the configured product dispensing channels using the dispensing modules, thus reducing opportunities for human errors.

In another embodiment, instead of trays 13, shelves (e.g., flat panels similar to 135 of the trays 13, but without the rear wall of the trays) having the slots 131 may be provided, and a rectangular array of connectors 132 (e.g., an L×M array female connectors) may be provided at a separate back panel towards the rear of the product chamber 211.

In one embodiment, one of the objectives of the invention to provide a vending machine 1 comprising a frame 11 including a display 111 on a front surface, a keypad 112 on the front surface, a sensor 113 on the front surface, a window 114 on the front surface, an opening 115 under the window 114, and a controller 116 for controlling the display 111, the keypad 112, and the sensor 113; a plurality of rows of product dispensing modules 12, each product dispensing module 12 including a body 121, a stop member 123 at one end of the body 121, a drive device 124 projecting outward from the stop member 123, a connector 125 projecting outward from the stop member 123, a biasing member (e.g., a corkscrew 126) having one end anchored on an inner surface of the stop member 123, and a display member 127 on the other end of the body 121 wherein the biasing member is one of a helical spring/corkscrew (FIG. 4A), two corkscrews (FIG. 5), and a conveyor (FIG. 6); and a plurality of trays 13, each for supporting the rows of the product dispensing modules 12 and including a plurality of cavities for securing to the product dispensing modules 12, and a plurality of connection members 132, each configured to connect to the connector 125.

The objects, features and advantages of the invention will become apparent from the following further detailed description considered in reference to the accompanying drawings.

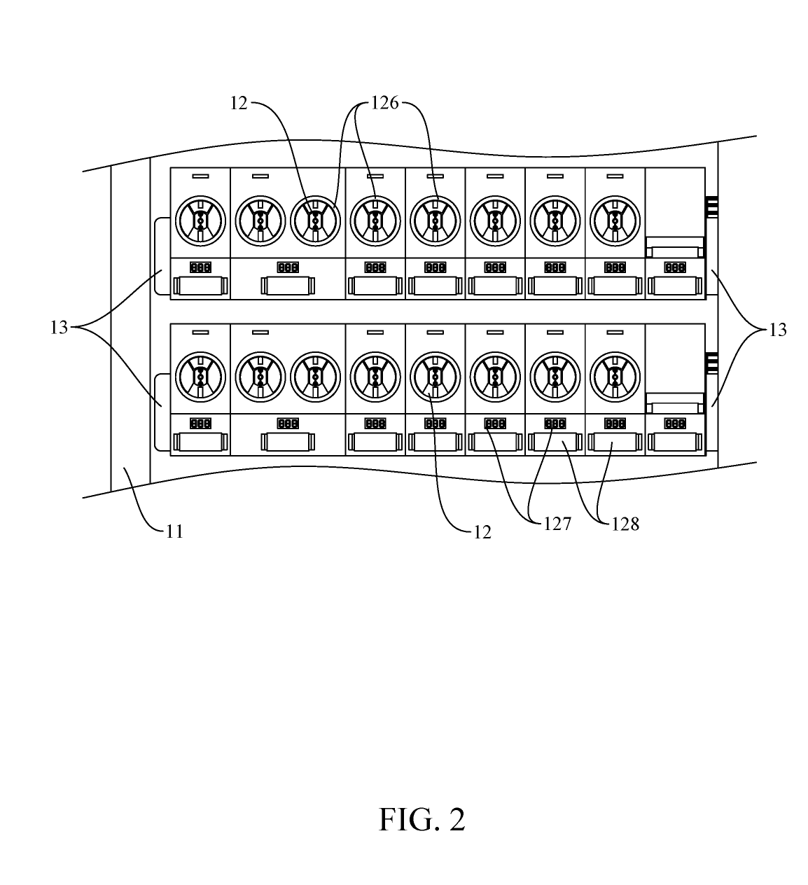

Referring to FIGS. 1 to 3, a vending machine 1 in accordance with the invention comprises a housing or frame 11, a plurality of rows of product dispensing modules 12 and a plurality of trays 13 as discussed in detail below.

The frame 11 includes a display (e.g., liquid-crystal display (LCD)) 111 on one side of a front surface, a keypad 112 under the display 111, a sensor 113 under the keypad 112, a transparent window 114 on a substantial portion of the front surface, displaying products supported by rows of dispensing modules in a product dispensing chamber 211, an opening 115 under the window 114, and a controller 116 adapted to transmit data to a remote management unit 2 via a wired and/or wireless network. A person may press the keys of the keypad 112 to select an item/product to be dispensed with the aid of the display 111. Further, in one embodiment, a virtual, or “soft”, keypad is provided on the display 111 as a backup so that the person may operate the vending machine 1 normally if the keypad 112 malfunctioned. Alternatively, or in addition, the display 111 may be touch sensitive, which could eliminate the need for a separate keypad. A magnetic card, a radio frequency identification (RFID) card, an integrated circuit (IC) card, or a mobile phone having a feature of near field communication (NFC) can be used to activate the sensor 113 for providing user identification authorizing dispensing of an item in the vending machine, which may include a required payment. Details of the purchase including item, time, date and quantity are transmitted to the controller 116 for processing.

Preferably, wireless transmission is performed via Wi-Fi or by a subscriber identity module (SIM) card (e.g., for a cellular network). The controller 116 may store details of the purchase temporarily locally in the vending machine if the wireless transmission is interrupted, to be later transmitted to the management unit 2 when wireless network is restored.

Referring to the embodiments illustrated FIGS. 4 to 6, the product dispensing module 12 includes an elongated body 121, a wall 122 on one side of the body 121 (this forms the dividing wall between adjacent dispensing modules 12), a stop member 123 at one end of the body 121, a drive device 124 projecting outward from the stop member 123, a connector 125 also projecting outward from the stop member 123 and under the drive device 124, a corkscrew 126 having one end anchored on an inner surface of the stop member 123, a digital display member 127 disposed on the other end of the body 121 adjacent to the other end of the spring 126, and a plate 128 under the display member 127. The modular product dispensing module 12 is self-contained, which can be replaced as a whole, including the entire product dispensing mechanism (which includes the drive mechanism (e.g., motor) and the product conveying mechanism (e.g., corkscrew(s), conveyor belt, hangers, etc.)). Information of the particular dispensing module (e.g., dispensing mechanism including drive mechanism and product conveying mechanism may be provided on the plate 128, such as the number of corkscrews 126 provided (one in FIG. 4 and two parallel corkscrews 126 in FIG. 5), or a belt conveyor 151 (FIG. 6) is shown on the plate 128. Further, information such as size and number of turns (defining the number of spaces available to accommodate certain size and number of products) of the corkscrew 126 may be shown on the plate 128.

Referring to FIGS. 7 and 8 in conjunction with FIG. 4, the tray 13 is used to support the product dispensing modules 12 and includes a bottom panel 135, a plurality of slots 131 for securing complementary protruding members 161 provided at the bottoms of dispensing modules 12 to the panel 135 of the tray 13, and a plurality of connection members 132 for connecting to the connectors 125 on the dispensing modules by snapping respectively. Once connected, electrical power is supplied to the display member 127 to show a serial number of the connector member 132, i.e., the serial number which is associated with the product dispensing module 12. Further, the controller 116 may detect whether the connection is secure or not. If yes, the serial number of the product dispensing module 12 is used. Otherwise, the serial number of the product dispensing module 12 is not used. This saves labor of manually labeling the serial number of the product dispensing module 12 on the plate 128. The tray 13 having side tabs 139 may be pulled out of the complementary tracks of the supporting rails 141 on the sidewalls of the product dispensing chamber 211, to facilitate removal or placement of dispensing modules 12.

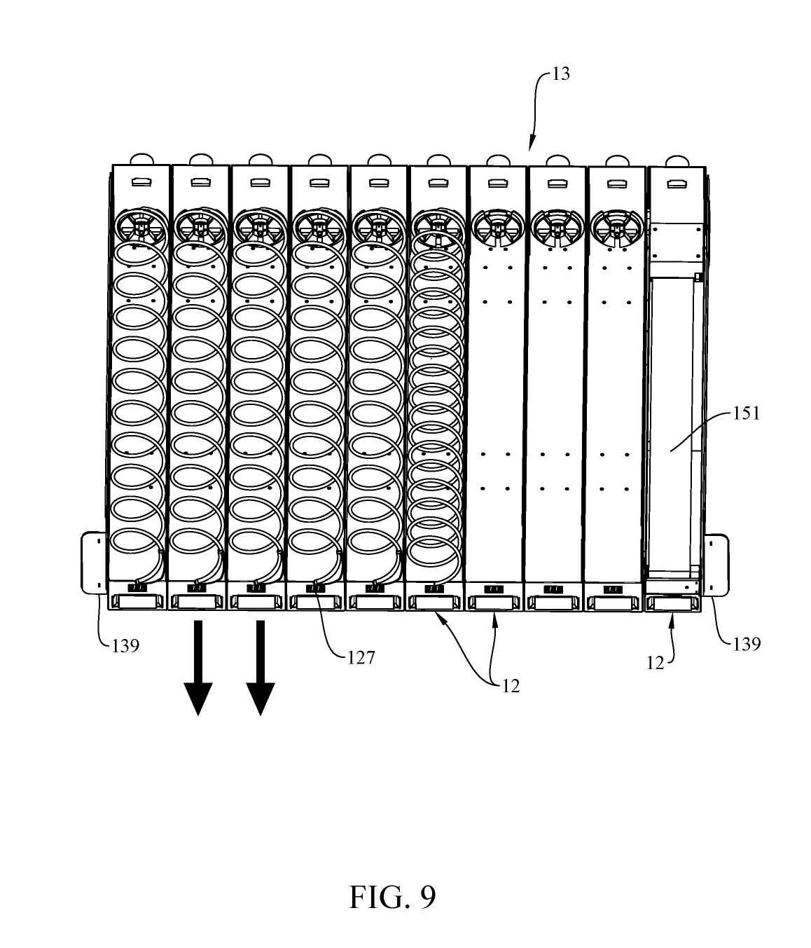

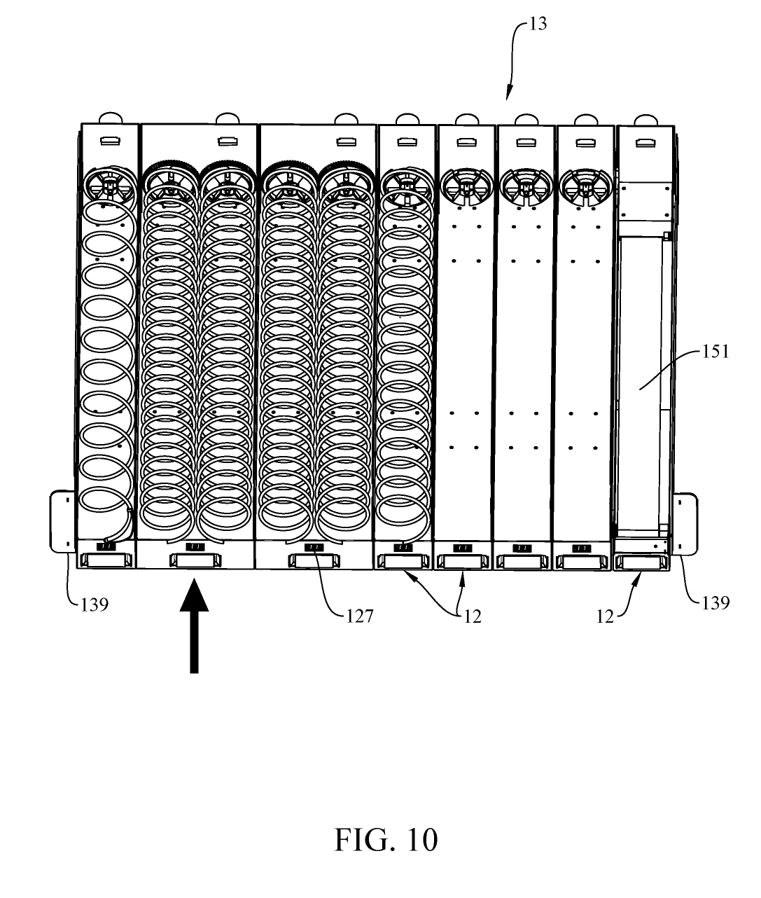

Referring to FIGS. 9 and 10 in conjunction with FIGS. 4 and 5, replacement/reconfiguration of single corkscrew product dispensing modules to a double size/double corkscrews product dispensing module is illustrated. In FIG. 9, a person may pull each of two product dispensing modules 12 in a direction indicated by arrows. Thereafter, the person may replace in the empty space with a product dispensing module 12 having two parallel complementary opposing corkscrews 126 (rotating in opposite directions/senses) and connect the connection member 132 to the connector 125 (see FIG. 10). Further, the display member 127 shows the serial number of the product dispensing module 12 if such connection is effected.

It is envisaged by the invention that a person may replace a malfunctioned product dispensing module 12 with a new one by pulling the tray 13.

In one embodiment, it is noted that the display member 127 only shows the serial number associated with its associated product dispensing module 12. That is, in the case of FIGS. 9 and 10, the serial numbers of two product dispensing modules 12 shown in the display members 127 are different from that of the two product dispensing modules 12 after location exchange.

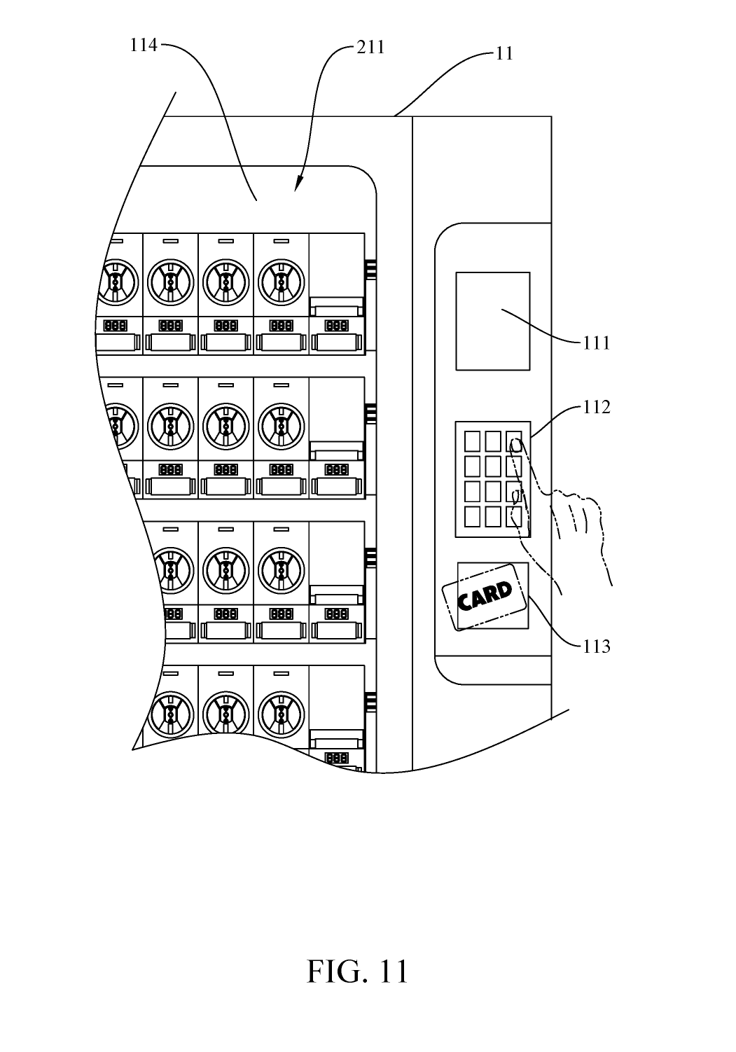

Referring to FIG. 11, an application of the vending machine of the invention is shown and described. The product is a glove, for example. A user (e.g., an employee of a factory) may view the display 111, press a key of the keypad 112 to select a glove based on the serial number associated and displayed on the dispensing module, and place his or her access card (e.g., an employee identification card) on the sensor 113 to activate the dispensing mechanism of the vending machine (e.g., a corkscrew rotating to advance the selected item or a belt conveyor advancing the selected item). As a result, the glove is dropped to the bottom of the space in front of the product dispensing chamber 211, where the user can retrieve the selected item through the opening 115 (which may be covered with a hinged flap/cover). Also, the controller 116 records details of the transaction. For example, an employee numbered A retrieves a glove from a product dispensing module labeled 12 on 9 AM, Aug. 21, 2017. The details of the transaction are sent to a remote management unit 2 by wire or wirelessly via a controller 116. A manager having access to the data in the remote management unit 2 may review the transactions monthly to determine the consumption of a particular product. Further, the manager may inform an external company to replenish the product if the consumption of the product is high and the inventory thereof is low, to have more precise manner.

In one embodiment, instead of a management unit 2 at a remote site connected to the vending machine via a network, a management unit 2 may be included locally within the vending machine, which data can be accessed remotely via a network.

While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

What is claimed is:

1. A vending machine, comprising:
a housing defining a product dispensing chamber;
a controller in the housing;
a plurality of modular dispensing modules defining product dispensing channels in the product dispensing chamber, wherein each dispensing module comprises a body supported in the dispensing chamber, wherein each dispensing module is self-contained, pre-configured with an integral drive mechanism comprising an actuator driving a product conveyor to advance a product supported in the dispensing module to be dispensed by the dispensing module, and provided with a first connector for receiving control signals from the controller;
a plurality of shelves, each supporting at least one dispensing module;
a frame in the product dispensing chamber supporting the shelves at various levels to support the dispensing modules at various levels; and
an array of second connectors connectable to the first connectors of the dispensing modules, wherein the array is fixedly arranged with respect to the frame, and wherein control signals from the controller is provided to the dispensing modules upon the first connector engaging the second connector.

2. The vending machine as in claim 1, wherein the dispensing modules form building blocks for configuring the product dispensing channels to accommodate dispensing products of various sizes and/or forms.

3. The vending machine as in claim 2, wherein the dispensing modules are plug-and-play, wherein configuration/reconfiguration of the product dispensing channels can simply be achieved by plugging in a desired set of pre-configured dispensing modules, which does not require formal or structured training of the vending machine operator.

4. The vending machine as in claim 3, wherein a desired dispensing module may be relocated in the vending machine without having to remove products supported in said desired dispensing module, thereby simplifying reconfiguration of the product dispensing channels in the vending machine.

5. The vending machine as in claim 1, wherein the dispensing modules are interchangeable with dispensing modules of similar form factor, and two or more dispensing modules of smaller form factor may be replaced by another dispensing module of larger form factor, or vice versa.

6. The vending machine as in claim 5, wherein the body of each dispensing module comprises has a width form factor that is a multiple of a smallest width form factor of the body of the narrowest dispensing module.

7. The vending machine as in claim 6, wherein the dispensing module comprises a first dispensing module having a first body of width W, a second dispensing module having a second body of a larger width substantially N×W, (where N=1, 1.5, 2, 2.5, 3, 3.5 . . . ) to accommodate wider products to be dispensed.

8. The vending machine as in claim 6, wherein the first connector is place in the same location with respect to a same side of each dispensing module of same or different form factor.

9. The vending machine as in claim 1, wherein upon the first connectors of the dispensing modules engaging the second connectors, the controller recognizes the second connectors that are active without user intervention, thereby identifying the locations of the dispensing modules with respect to the product dispensing chamber.

10. The vending machine as in claim 1, wherein upon connecting the first and second connectors, the controller recognizes the second connectors on the shelves that are active, thereby recognizing the locations of the dispensing modules with respect to the product dispensing chamber.

11. The vending machine as in claim 10, wherein the body of each dispensing module comprises one or more protruding members at a base of the body, which engage complementary one or more slots on a supporting shelf to positively and accurately index the dispensing module at a location on the supporting shelf, whereby the first connector at the rear of each dispensing module is aligned and connect with a second connector.

12. The vending machine as in claim 1, wherein the shelf is in the form of a tray, comprising a linear array of second connectors at fixed spacing provided at a rear wall of the tray.

13. The vending machine as in claim 12, the linear array of second connectors has a centerline spacing conforms to centerline spacing of the first connectors on a horizontal row of dispensing modules of the smallest width form factor.

14. The vending machine as in claim 12, wherein the body of each dispensing module comprises one or more protruding members at a base of the body, which engage complementary one or more slots on a supporting shelf to positively and accurately index the dispensing module at a location on the supporting shelf, whereby the first connector at the rear of each dispensing module is aligned and connect with a second connector.

15. The vending machine as in claim 1, wherein the body of each dispensing module comprises a digital display at front of the body to identify the dispensing module to distinguish from another dispensing module.

16. The vending machine as in claim 1, wherein each the body of each dispensing module comprises a wall on one side of the body, thereby providing a partition wall with an adjacent dispensing module.

17. The vending machine as in claim 1, wherein the actuator comprises a motor drive.

18. The vending machine as in claim 17, wherein the product conveyor comprises at least one of a corkscrew conveyor and a belt conveyor.

19. The vending machine as in claim 18, wherein the corkscrew conveyor comprises at least one of a single corkscrew and a double corkscrew.

20. The vending machine as in claim 1, further comprising a dispensing location defined in the housing at the base of the dispensing chamber for users to retrieve product items dispensed by the dispensing modules.
